(19) United States
(12) Patent Application Publication
(10) Pub. No.: US 2015/0325050 A1
(43) Pub. Date: Nov. 12, 2015

(54) APPARATUS AND METHOD FOR PROVIDING AUGMENTED REALITY

(71) Applicant: Samsung Electronics Co., Ltd., Suwon-si (KR)

(72) Inventors: Yo Han Roh, Hwaseong-si (KR); Joo Hyuk Jeon, Seoul (KR); Seok Jin Hong, Hwaseong-si (KR); Kyoung Gu Woo, Seoul (KR); Sang Hyun Yoo, Seoul (KR); Ji Hyun Lee, Hwaseong-si (KR); Ho Dong Lee, Yongin-si (KR)

(73) Assignee: SAMSUNG ELECTRONICS CO., LTD., Suwon-si (KR)

(21) Appl. No.: 14/526,251

(22) Filed: Oct. 28, 2014

(30) Foreign Application Priority Data
May 7, 2014 (KR) 10-2014-0054367

(51) Int. Cl. G06T 19/00; G06F 17/24

(52) U.S. Cl. CPC G06T 19/006; G06F 17/241

(57) ABSTRACT

A personalized augmented reality providing apparatus includes an interest object determiner configured to determine an interest object among external objects each having a predetermined relationship with a user, a relationship identifier configured to identify a subjective relationship between the interest object determined by the interest object determiner and the user, an additional information generator configured to generate additional information representing a current relationship state between the interest object and the user based on the subjective relationship identified by the relationship identifier, and an additional information provider configured to provide the user with the additional information generated by the additional information generator.

### CROSS-REFERENCE TO RELATED APPLICATIONS

This application claims the benefit under 35 USC 119(a) of Korean Patent Application No. 10-2014-0054367 filed on May 7, 2014, in the Korean Intellectual Property Office, the entire disclosure of which is incorporated herein by reference in its entirety for all purposes.

### BACKGROUND

1. Field

The following description relates to an apparatus for providing augmented reality and a method of providing augmented reality.

2. Description of Related Art

Augmented reality (AR) is technology that enables a virtual object or information to appear in a real environment by combining the virtual object or information with the environment, that is, technology for representing a three-dimensional virtual object overlaid on the real world. As opposed to Virtual Reality (VR) that only deals with a virtual space and a virtual object, AR is combines a virtual object with the real world to provide enhanced additional information that cannot be obtained only from the real world. Accordingly, AR can be applied to various real world environments, as opposed to VR that is only applied to limited areas such as games, and thus AR is gaining popularity as a next-generation display technology suitable for ubiquitous environments.

In addition, AR is also referred to as Mixed Reality (MR), which merges a virtual world having additional information with the real world to show a single image in real time. AR, which represents a Hybrid VR system of merging a real environment with a virtual environment while providing a concept of enabling a real world to be supplemented with a virtual world, uses a virtual environment generated by computer graphics, but the real world is a principal part in AR. Computer graphics serve to additionally provide required information for the real world. A three-dimensional virtual image is overlaid on a picture viewed by a user to obscure the distinction between a real environment and a virtual environment, thereby providing an enhanced perception of reality and additional information.

Various examples of AR providing methods have been suggested. For example, when a tourist walking on a street in London points at a certain point using a camera of a mobile phone that incorporates various technologies including a camera, a GPS sensor, and so on, AR may show, as augmented reality information, a real image of the street overlaid with information such as names of restaurants located in the direction of the point or stores having a sale located in the direction of the point.

As another example, when a user wearing a Head Mounted Display (HMD) device having an AR providing function watches a baseball game, AR may show the user a real view of the baseball game overlaid with information about a pitcher and a batter in the user's field of view, for example the name and earned run average of the pitcher, or the name, batting averages, slugging percentage, and on-base percentages of the batter. As another example, when a spectator wearing a Head Mounted Display (HMD) device having an AR providing function watches an opera, the AR may show the spectator the real performance overlaid with a translation of the opera's libretto.

As described above, the existing examples of the AR providing methods provide information about an object. Even if the location, line of vision, and path of a user are considered in providing the above described information, they are only used with regard to selecting an object, such as selecting an object whose information is to be provided.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The following description relates to an apparatus for providing augmented reality and a method of providing augmented reality for providing a user with appropriate information depending on a current situation in consideration of a relationship between a user and an interest object of the user, that is, a human or object that of an interest to the user.

In one general aspect, a personalized augmented reality providing apparatus includes an interest object determiner configured to determine an interest object among external objects each having a predetermined relationship with a user; a relationship identifier configured to identify a subjective relationship between the interest object determined by the interest object determiner and the user; an additional information generator configured to generate additional information representing a current relationship state between the interest object and the user based on the subjective relationship identified by the relationship identifier; and an additional information provider configured to provide the user with the additional information generated by the additional information generator.

The interest object determiner may be further configured to determine the interest object based on an input of the user or information acquired through a smart electronic device controlled by the user.

The relationship identifier may be further configured to identify the subjective relationship with respect to the user by recognizing the interest object determined by the interest object determiner from an image acquired by a smart electronic device controlled by the user.

The personalized augmented reality providing apparatus may further include a storage configured to store an interest object list in which interest objects for which the additional information is to be provided to the user are registered; and the interest object determiner may be further configured to determine, as the interest object, an external object included in the interest object list among the external objects.

The interest object list may include subjective relationship information indicating the subjective relationship for each of the interest objects registered in the interest object list; and the relationship identifier may be further configured to identify the subjective relationship with respect to the user using the subjective relationship information in the interest object list.

The storage may be further configured to store subjective interaction information expressing an interaction previously occurring between the user and each of the interest objects registered in the interest object list; and the additional information generator may be further configured to generate the additional information using the subjective interaction information.

The additional information generator may be further configured to generate the additional information using objective object information about each of the interest objects.

The objective object information may be stored in the storage or acquired by the additional information generator through communication with an external database.

The current relationship state may indicate an interaction expressed by the subjective interaction information or indicates a recommended interaction determined using an interaction expressed by the subjective interaction information and the objective object information.

The additional information provider may be further configured to select the additional information generated by the additional information generator according to a predetermined priority, and provide the selected additional information to the user.

The priority may be set by the user in advance, or determined in order of a most recent time.

In another general aspect, a personalized augmented reality providing method includes determining an interest object among external objects each forming a predetermined relationship with a user; identifying a subjective relationship between the determined interest object and the user; generating additional information representing a current relationship state between the interest object and the user based on the identified subjective relationship; and providing the user with the generated additional information.

The determining of the interest may include determining the interest object based on an input of the user or information acquired through a smart electronic device controlled by the user.

The determining of the interest object may include determining an external object included in an interest object list in which interest objects are registered to be the interest object among the external objects.

The interest object list may include subjective relationship information indicating the subjective relationship for each of the interest objects registered in the interest object list; and the identifying of the subjective relationship may include identifying the subjective relationship with respect to the user using the subjective relationship information in the interest object list.

The interest object list may include subjective interaction information expressing an interaction previously occurring between the user and each of the interest objects registered in the interest object list; and the generating of the additional information may include generating the additional information using the subjective interaction information.

The generating of the additional information may include generating the additional information using objective object information about each of the interest objects.

The objective object information may be stored in the interest object list or acquired through communication with an external database.

The current relationship state may indicate an interaction expressed by the subjective interaction information, or indicates a recommended interaction determined using an interaction expressed by the subjective interaction information and the objective object information.

The providing of the user with the generated additional information may include selecting the generated additional information according to a predetermined priority, and providing the selected additional information to the user.

In another general aspect, a personalized augmented reality providing apparatus includes an additional information generator configured to generate additional information about a relationship state between an external object and a user based on a relationship between the external object and the user; and an additional information provider configured to provide the user with the additional information.

The personalized augmented reality providing apparatus may further include an object determiner configured to identify the external object from a plurality of external objects each having a predetermined relationship with the user.

The personalized augmented reality providing apparatus may further include a relationship identifier configured to identify the relationship between the external object and the user.

The additional information generator may be further configured to generate the additional information based on any one or any combination of relationship information indicating the relationship between the external object and the user; interaction information expressing a previous interaction between the external object and the user; and object information about the external object.

The relationship state may indicate an interaction expressed by the interaction information or a recommended interaction determined based on the previous interaction expressed by the interaction information and the object information.

Other features and aspects will be apparent from the following detailed description, the drawings, and the claims.

### BRIEF DESCRIPTION OF THE DRAWINGS

FIG. 1 illustrates an example of a configuration of an augmented reality providing apparatus.

FIG. 2 illustrates an example of a storage.

FIG. 3 illustrates an example of an interest object determining method.

FIG. 4 illustrates another example of an interest object determining method.

FIG. 5 illustrates an example of an interest object list.

FIG. 6 illustrates an example of an additional information generating method.

FIG. 7 illustrates another example of an additional information generating method.

FIG. 8 illustrates another example of an additional information generating method.

FIG. 9 illustrates an example of a relationship-based personalized augmented reality providing method.

FIGS. 10 to 13 illustrate examples of a relationship-based personalized augmented reality provided to a user.

### DETAILED DESCRIPTION

The following description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness. In addition, terms used herein are defined in consideration of functions in the this disclosure and may be changed according to the intentions of a user or an operator or conventional practice. Therefore, the definitions are to be based on the content throughout this disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

It is to be understood that the term “object”, when used in this disclosure, specifies a marker existing in the real world and an object or state in a markerless-based technology, that is, “object” represents all that can be defined in the real world. The term “interest object”, when used in this disclosure, does not represent all objects or states existing in the real world, but represents an object having a predetermined relationship with a user among general objects and having a subjective interest to the user. Hereinafter, an augmented reality providing apparatus and an augmented reality providing method will be described in detail with reference to the accompanying drawings.

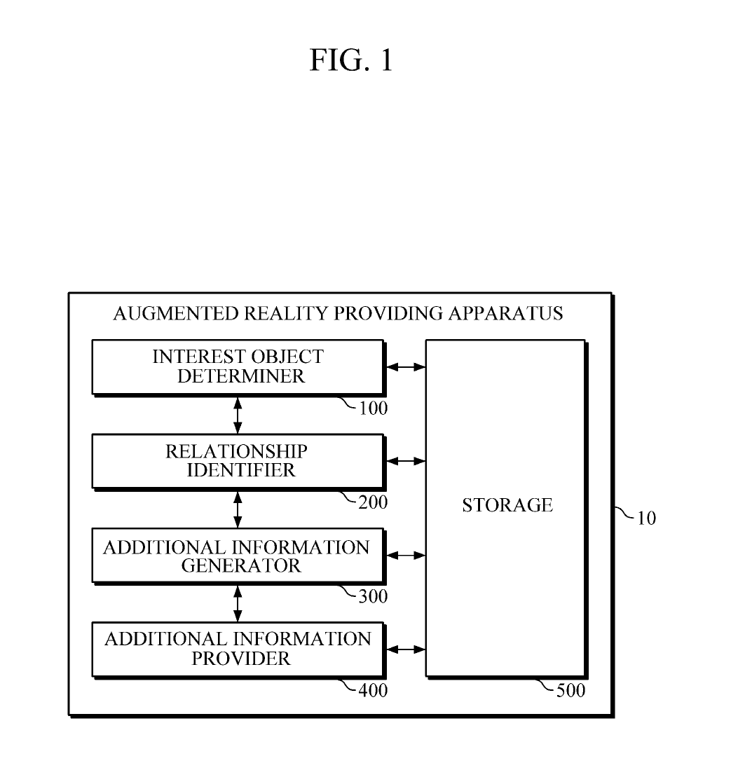

FIG. 1 illustrates an example of a configuration of an augmented reality providing apparatus.

Referring to FIG. 1, an augmented reality providing apparatus 10 includes an interest object determiner 100, a relationship identifier 200, an additional information generator 300, an additional information provider 400, and a storage 500. The configuration shown in FIG. 1 is for illustrative purposes only. Accordingly, the augmented reality providing apparatus 10 may be provided with only some of the elements shown in FIG. 1, and/or further provided with one or more other elements needed for an operation of the augmented reality providing apparatus 10.

The interest object determiner 100 determines an interest object among external objects, each of has a predetermined relationship with a user. The determining of an interest object corresponds to selecting an object, for which additional information is to be provided to a user through the additional information provider 400, among one or more objects interacting with the user. An object interacting with the user is a person whom the user meets, an object the user contacts or holds using his hands or feet, an object the user looks at, a person or object the user talks about, or a person or object associated with the user through any of the five senses, for example, a sound or music the user listens to. For example, the interest object may be a person ‘James Goodwill’ whom the user meets, a person ‘Anna Kendrick’ whom the user looks at, an object ‘canned coffee’ the user holds using his hands, or an object ‘a potted rose’ the user looks at.

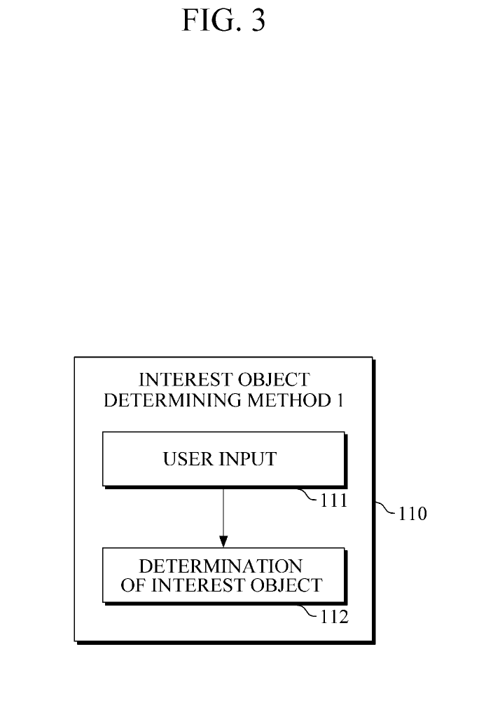

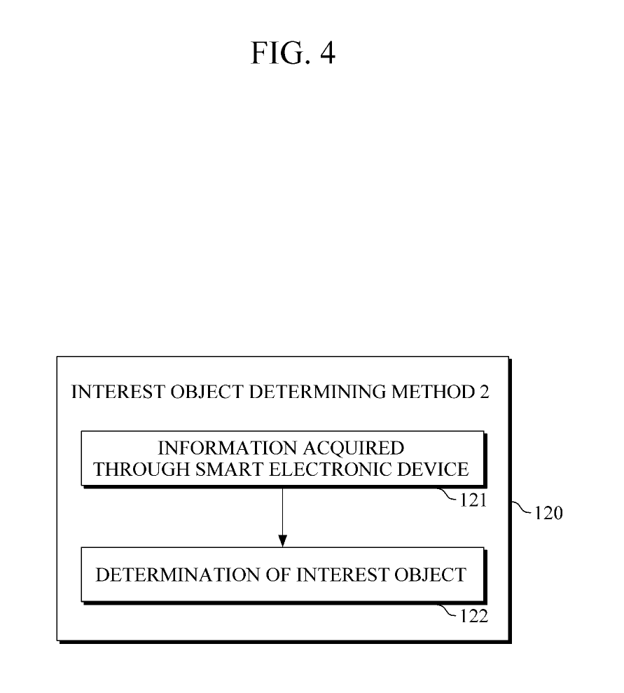

The interest object may be determined based on a user's input or information acquired through a smart electronic device controlled by the user, but the determining of the interest object is not limited thereto. Examples of a method of determining an interest object will be described in detail with reference to FIGS. 3 and 4.

The relationship identifier 200 identifies a subjective relationship between the interest object determined by the interest object determiner 100 and the user. A subjective relationship with a certain interest object may be set by the user in advance, or may be automatically determined based on information the user holds. In the former case, the subjective relationship information may be stored in a predetermined database, for example, in an interest object list that will be described later. In this case, the relationship identifier 200 identifies a subjective relationship specified in the database. In the latter case, the relationship identifier 200 identifies the subjective relationship based on personal information, contact information, schedule information, emails sent or received, and photos that are stored in a computer or smartphone possessed by a user.

In this case, the subjective relationship represents a unique relationship between a user and the corresponding interest object. Accordingly, even the same interest object may lead to a different subjective relationship depending on whom the user is. As an example, even if an interest object of each of a plurality of users is ‘James Goodwill’, a subjective relationship between the interest object ‘James Goodwill’ and one user may be ‘a business partner’, a subjective relationship between the interest object ‘James Goodwill’ and another user may be ‘a family’, a subjective relationship between the interest object ‘James Goodwill’ and another user may be ‘a friend’, a subjective relationship between the interest object ‘James Goodwill’ and another user may be ‘a boss’, and a subjective relationship between the interest object ‘James Goodwill’ and another user may be ‘a subordinate’. As another example, when an interest object of a user is ‘canned coffee’, a subjective relationship with respect to the user may ‘a relationship regarding intake’, and when an interest object of the user is ‘a potted rose’, a subjective relationship with respect to the user may ‘a relationship regarding watering’. However, a subjective relationship between another user and the canned coffee or the potted rose may be ‘a relationship regarding selling’.

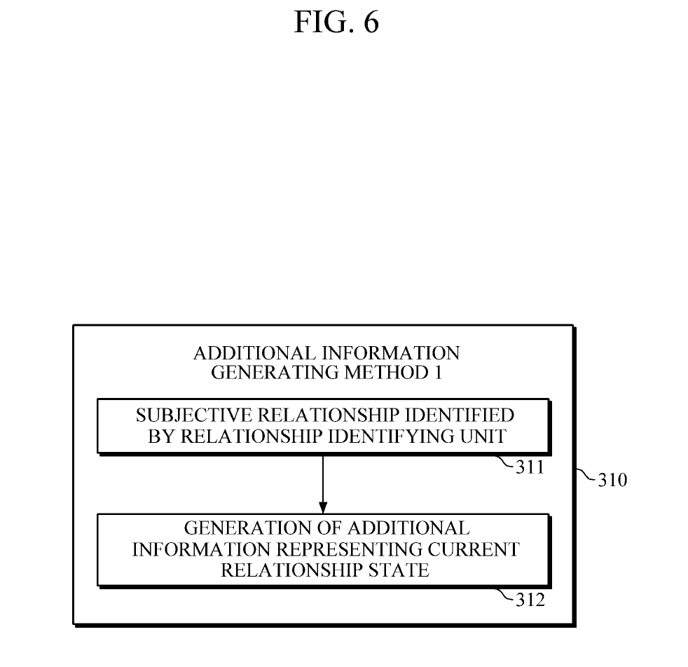

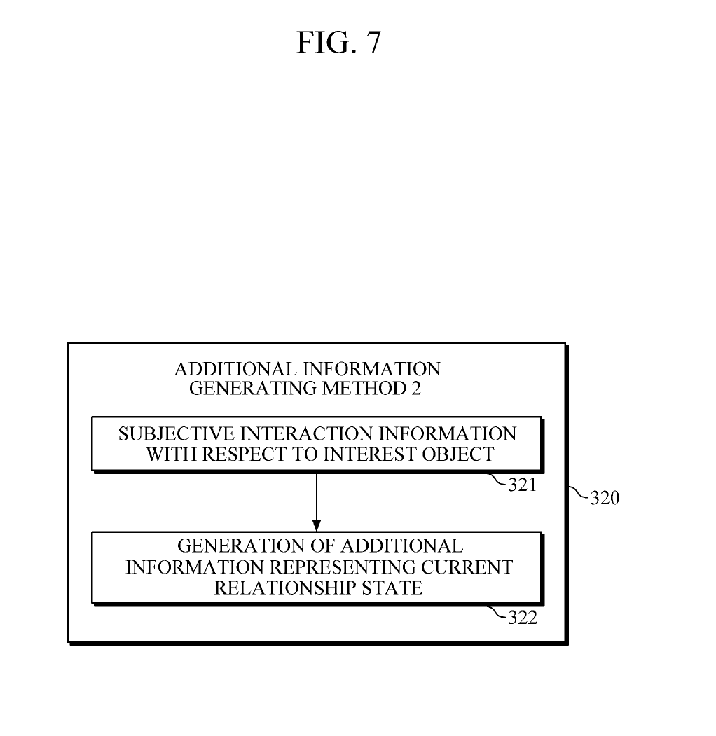

The additional information generator 300 generates additional information representing a current relationship state between an interest object and a user. The generating of additional information corresponds to generating information that is to be provided to a user with respect to the interest object determined by the interest object determiner 100 through the additional information provider 400. In this case, the additional information may be generated using the subjective relationship identified by the relationship identifier 200. Alternatively, the additional information may be generated using subjective interaction information that expresses an interaction previously occurring between the user and each of the interest objects registered in the interest object list. Alternatively, the additional information may be generated using subjective interaction information with respect to each interest object and objective object information about each interest object. The additional information generated using the subjective interaction information with respect to each interest object and the objective object information about each interest object may be a recommended interaction that is provided to the user. Examples of a method of generating additional information will be described in detail with reference to FIGS. 6 and 7.

The additional information provider 400 provides a user with the additional information generated by the additional information generator 300. The user using the augmented reality providing apparatus may allow additional information to be displayed together with an interest object, or allow only additional information to be displayed. However, the displaying of the additional information is not limited thereto. For example, when an interest object of a user is ‘James Goodwill’, all or a part of subjective relationship information with respect to the user, ‘business relationship’, subjective interaction information with respect to the user, ‘information about a previous meeting and recent emails’, and objective object information with respect to the user, ‘contact and email addresses’, may be provided to be displayed as additional information.

In addition, in this case, the additional information generated by the additional information generator 300 may be selected based on a predetermined priority and provided to a user. In this case, the priority may be set by the user in advance, or determined in the order of a most recent time. The providing of the additional information is not limited thereto, however. For example, when an interest object of a user is ‘James Goodwill’ and additional information generated by the additional information generator 300 includes ‘a plurality of pieces of recent email information’, the plurality of pieces of recent email information may be sorted in a descending order of the sent dates so that the additional information is provided starting with the most recent email information.

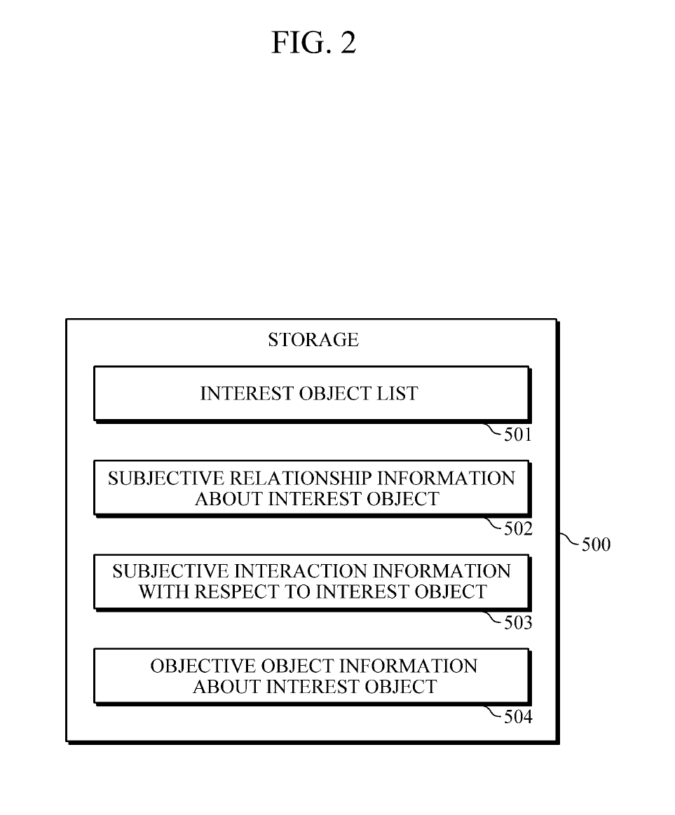

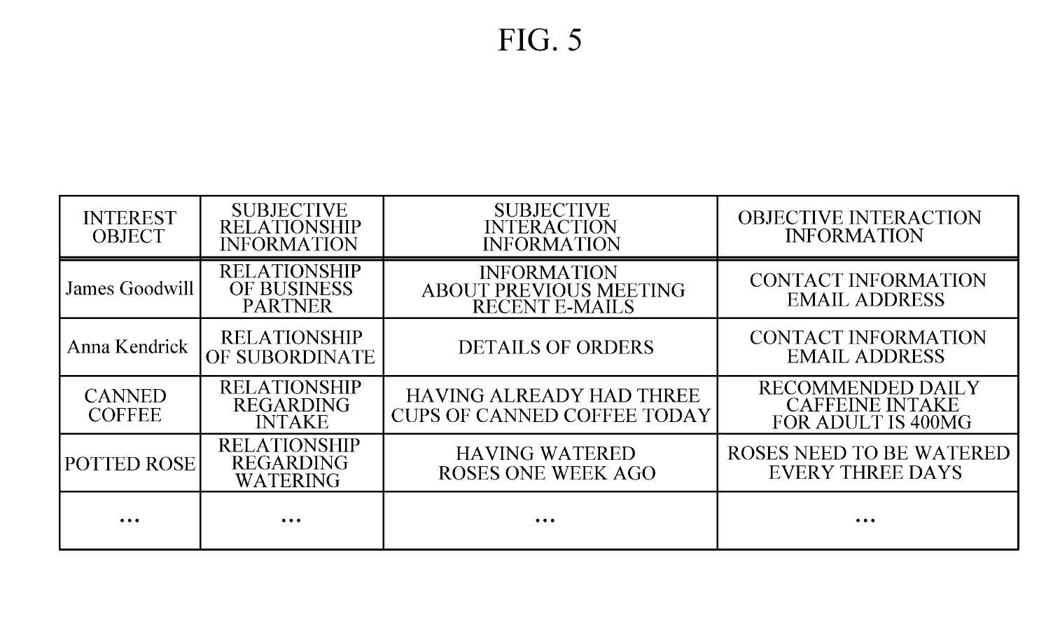

The storage 500 stores an interest object list in which interest objects for which additional information is to be provided to a user are registered. The interest object list may store not only the interest object, but also store subjective relationship information about the interest object, subjective interaction information with respect to the interest object, and objective object information about the interest object together with the interest object. An example of interest object list will be described in detail with reference to FIG. 5. Meanwhile, the interest object determiner 100, the relationship identifier 200, the additional information generator 300, and the additional information provider 400 may use the storage 500 to acquire information about the interest object list. An example of the storage 500 will be described later in detail with reference to FIG. 2.

FIG. 2 illustrates an example of a storage.

Referring to FIG. 2, the storage 500 includes an interest object list 501, subjective relationship information about an interest object 502, subjective interaction information with respect to an interest object 503, and objective object information about an interest object 504. The configuration of the storage 500 shown in FIG. 2 is for illustrative purposes only, and the storage 500 may store only some of the information shown in FIG. 2, and/or store other information.

The interest object list 501 is a list of interest objects that have an association or correlation with a user and form a subjective relationship with the user. For example, ‘James Goodwill’, ‘Anna Kendrick’, ‘canned coffee’, and ‘a potted rose’ that form a subjective relationship with a user may be included in an interest object list.

The subjective relationship information about an interest object 502 is unique association information between a corresponding interest object and a user. Accordingly, even the same interest object may lead to different subjective relationship information depending on whom the user is. The subjective relationship information has been described in detail with reference to FIG. 1.

The subjective interaction information with respect to an interest object 503 is an interaction previously occurring between a user and each of the interest objects. Accordingly, even the same interest object may lead to different subjective interaction information depending on whom the user is. The subjective interaction information will be described in detail with reference to FIG. 7.

The objective object information about an interest object 504 is a general fact or information about an object. Accordingly, in contrast to the subjective relationship information and the subjective interaction information, the objective object information does not change depending on whom the user is. For example, when an interest object is ‘canned coffee’, objective object information about ‘canned coffee’ may be ‘a recommended daily caffeine intake for adult is 400 mg’, or the price or manufacturer of the ‘canned coffee’.

In this case, the objective object information 504 may be stored in the storage 500 of the augmented reality providing apparatus 10, or acquired through the additional information generator 300 by communicating with an external database, but the acquisition of the objective object information is not limited thereto. Meanwhile, when the data is received from an external database through an external network, the augmented reality providing apparatus 10 in FIG. 1 may further include a communication interface that performs a network communication.

FIGS. 3 and 4 illustrate examples of an interest object determining method.

Referring to FIG. 3, in a first interest object determining method 110, a determination 112 of an interest object may be performed based on a user's input 111. That is, a user may determine an interest object whose additional information is desired by the user by directly inputting information about the interest object. In this case, the user may directly enter the name of an interest object to determine the interest object. Alternatively, the interest object may be indirectly determined as the user enters objective object information about an interest object to search for the interest object, but the determining of the interest object is not limited thereto. For example, when an interest object of a user is a person ‘James Goodwill’, the user may directly enter the name of the person ‘James Goodwill’ to determine the interest object. Alternatively, for the indirect method, the user may search for an interest object ‘James Goodwill’ by entering objective object information, such as contact information or mail address of ‘James Goodwill’, thereby determining ‘James Goodwill’ as the interest object.

Referring to FIG. 4, in a second interest object determining method 120, a determination 122 of an interest object may be performed based on information 121 acquired through a smart electronic device controlled by a user. The smart electronic device may be a mobile communication terminal, such as a personal digital assistant (PDA), a smartphone, or a navigation terminal, or any other device capable of recognizing an object existing in the real world and outputting augmented reality information corresponding to the recognized object, for example, a personal computer, such as a desktop computer or a notebook computer. For example, a user, by using a camera or an image sensor of a smartphone or other device that may acquire an image, acquires an image about an interest object so that the augmented reality providing apparatus acquires information about the interest object, so that the interest object may be determined. In this case, the smartphone or other device may send the augmented reality providing apparatus an interest object that is determined when it is identified from the image directly acquired by the smartphone or other device. Alternatively, when the smartphone or other device sends the augmented reality providing apparatus the image directly acquired by the smartphone or other device, the augmented reality providing apparatus may determine an interest object from the received image. However, the determining of the interest object is not limited thereto. In the example shown in FIG. 3, a user may acquire a picture of ‘James Goodwill’ from a smartphone or other device, and ‘James Goodwill’ may be determined as an interest object.

FIG. 5 illustrates an example of an interest object list.

Referring to FIG. 5, the interest object list may be constructed in the form of a file or a table, but the construction of the interest object list is not limited thereto. The interest object list may store items including interest objects, subjective relationship information, subjective interaction information, and objective object information. In addition, the interest object list may further include additional information that may represent information about the interest object. The construction of the interest object list is not limited thereto, however. In this case, the objective object information may be stored in the storage 500 or acquired through the additional information generator 300 by communicating with an external database. That is, the interest object list may vary with a user.

For example, when an interest object of a user is ‘James Goodwill’, subjective relationship information may be ‘a business partner’, subjective interaction information may be ‘information about a previous meeting and recent emails’, and objective object information may be ‘contact information and email address of James Goodwill’. In addition, when an interest object of a user is ‘Anna Kendrick’, subjective relationship information may be ‘a subordinate’, subjective interaction information may be ‘details of orders’, and objective object information may be ‘contact information and email address of Anna Kendrick’. In addition, when an interest object of a user is ‘canned coffee’, subjective relationship information may be ‘a relationship regarding intake’, subjective interaction information may be ‘having already had three cups of canned coffee today’, and objective object information may be ‘a recommended daily caffeine intake for adult is 400 mg’. In addition, when an interest object of a user is a ‘potted rose’, subjective relationship information may be ‘a relationship regarding watering’, subjective interaction information may be ‘having watered roses one week ago’, and objective object information may be ‘roses need to be watered every three days’.

However, even with the same interest object, subject relationship information or subjective interaction information may vary with a user. For example, when a plurality of users have the same interest object ‘James Goodwill’, subjective relationship information may be a ‘family’, ‘friend’, or ‘boss’ depending on who the user is. For example, when an interest object is ‘canned coffee’ or ‘a potted rose’, subjective relationship information may be ‘a relationship regarding selling’ depending on a user. In addition, subjective interaction information may vary with a user. However, the objective object information may be the same regardless of a user.

FIGS. 6 to 8 illustrate examples of an additional information generating method.

Referring to FIG. 6, in a first additional information generating method 310, generation of additional information representing a current relationship state 312 may be performed based on a subjective relationship 311 identified by the relationship identifier 200. For example, when an interest object of a user is ‘James Goodwill’, subjective relationship information between the interest object ‘James Goodwill’ and the user may be ‘a business partner’. However, even if an interest object of another user is also ‘James Goodwill’, subjective relationship information between the interest object ‘James Goodwill’ and the other user may be ‘family’, ‘friend’, ‘boss’, or ‘subordinate’.

For example, when an interest object of a user is ‘canned coffee’, a subjective relationship with respect to the user may be ‘a relationship regarding intake’, and when an interest object of the user is ‘a potted rose’, a subjective relationship with respect to the user may be ‘a relationship regarding watering’. However, the interest object ‘canned coffee’ or ‘a potted rose’ may have a subjective relationship ‘a relationship involving selling’ with respect to another user.

Referring to FIG. 7, in a second additional information generating method 320, generation of additional information representing a current relationship state 322 may be performed based on subjective interaction information 321 with respect to an interest object. Subjective interaction information with respect to an interest object expresses an interaction previously occurring between a user and each interest object. The subjective interaction information with respect to an interest object may be registered in an interest object list, but is not limited thereto. As an example, when an interest object of a user is ‘James Goodwill’, subjective interaction information may be ‘information about a previous meeting and recent emails’. However, for another user, the same interest object ‘James Goodwill’ may result in subject interaction information ‘details of family members, family anniversaries, and a previous family gathering’ or ‘birthdays of friends, previous gatherings’ or ‘details of orders’ with respect to the other user.

As another example, when an interest object of a user is ‘canned coffee’, subjective interaction information may be ‘having already had three cups of canned coffee today’. Alternatively, when an interest object of a user is ‘a potted rose’, subjective interaction information may be ‘having watered roses one week ago’. However, subjective interaction information with respect to another user for an interest object ‘canned coffee’ may be ‘the sales of canned coffee yesterday are 30 cans, the sales of canned coffee last week are 100 cans, and the cumulative sales of canned coffee this month are 300 cans’.

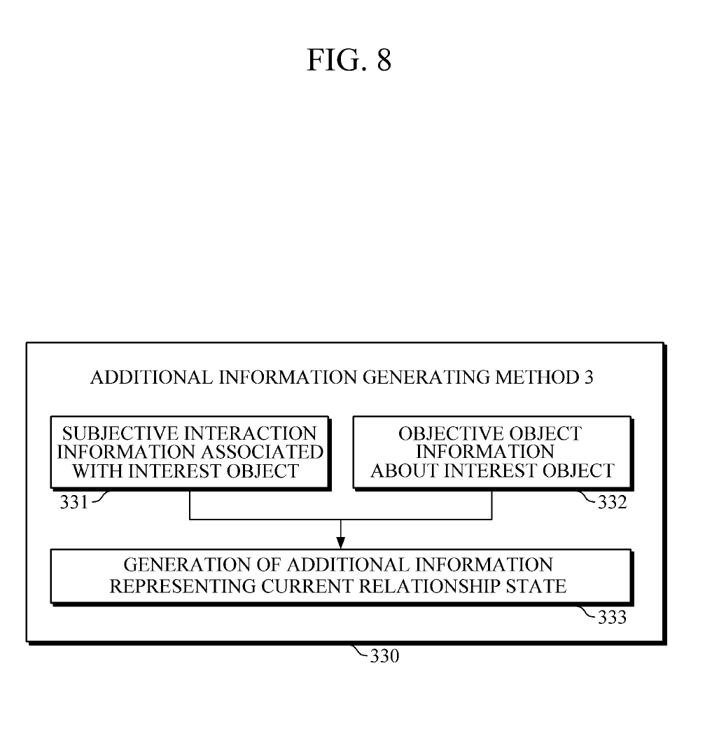

Referring to FIG. 8, in a third additional information generating method 330, generation of additional information representing a current relationship state 333 may be performed using subjective interaction information 331 with respect to the interest object and objective object information 332 about the interest object. The objective object information about an interest object is a general fact or information about an object. In this case, the additional information generated using the subjective interaction information 331 with respect to the interest object and the objective object information 332 about the interest object may be a recommended interaction that is provided to a user. The recommended interaction suggests an interaction that may be expected by a user with respect to an interest object by considering objective object information about the interest object and referring to subjective interaction information with respect to the interest object, but the recommended interaction is not limited thereto. Since the recommend interaction is generated by referring to subjective interaction information with respect to an interest object, the same objective object information about an interest object may result in a different recommended interaction depending on whom the user is.

As an example, when an interest object of a user is ‘James Goodwill’, objective object information may be ‘contact information and email address of James Goodwill’. In this case, by using subjective interaction information ‘information about a previous meeting and recent emails’ associated between the interest object ‘James Goodwill’ and the user, and using objective object information about James Goodwill ‘contact information and email address of James Goodwill’, additional information ‘sending James Goodwill an email regarding the previous meeting’ may be generated as a recommended interaction to be provided to the user. However, even if an interest object of another user is also ‘James Goodwill’, subjective interaction information with respect to the other user may be ‘information about family members, family anniversaries, and a previous family gathering’ or ‘birthdays of friends, previous gatherings’, or ‘details of orders’. In this case, additional information ‘preparing for a family anniversary’ or ‘making contact with regard to the next meeting’ or ‘reporting to a boss the meeting result’ may be provided to the other user as a recommended interaction.

As another example, when an interest object of a user is ‘Anna Kendrick’, objective object information about the interest object may be ‘contact information and email address of Anna Kendrick’. In this case, by using subjective interaction information ‘details of orders’ associated between the interest object ‘Anna Kendrick’ and the user, and using objective object information about Anna Kendrick ‘contact information and email address of Anna Kendrick’, additional information ‘querying Anna Kendrick whether a design draft of a mobile device A is completed’ may be generated to be provided to the user as a recommended interaction.

As another example, when an interest object of a user is ‘canned coffee’, objective object information about the interest object may be ‘a recommended daily caffeine intake for adult is 400 mg’. In this case, by using subjective interaction information ‘having already had three cups of canned coffee today’ associated between the interest object ‘canned coffee’ and the user, and using objective object information about canned coffee ‘a recommended daily caffeine intake for adult is 400 mg’, additional information ‘having more coffee will exceed 400 mg of caffeine, the recommended daily caffeine intake for adult, and no more coffee is recommended’ is generated as a recommended interaction to be provided to the user. However, even if an interest object of another user is also “canned coffee”, subjective interaction information with respect to the other user may be ‘the sales of canned coffee yesterday are 30 cans, the sales of canned coffee last week are 100 cans, and the cumulative sales of canned coffee this month are 300 cans’. In this case, additional information 100 more cans of canned coffee must be sold in order to reach a sales target′ is generated as a recommended interaction to be provided to a user.

As another example, when an interest object of a user is ‘a potted rose’, objective object information about the interest object may be ‘roses need to be watered every three days’. In this case, by using subjective interaction information ‘having watered roses one week ago’ associated between the interest object ‘potted rose’ and the user, and using objective object information ‘roses need to be watered every three days’, additional information ‘the date for watering the potted roses has passed already and prompt watering is required’ may be generated as a recommended interaction to be provided to the user. However, even if an interest object of another user is also ‘a potted rose’, subjective interaction information with respect to the other user may be ‘having watered roses yesterday’. In this case, additional information ‘there is no need to water the potted roses’ may be generated as a recommended interaction to be provided to the user.

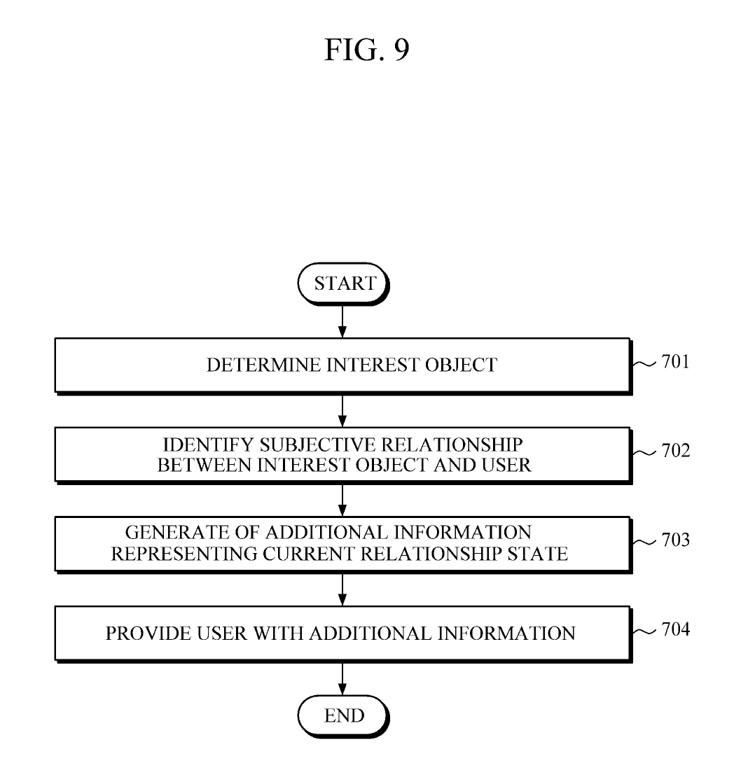

FIG. 9 illustrates an example of a relationship-based personalized augmented reality providing method.

Referring to FIG. 9, first, a user determines an interest object among external subjects each forming a predetermined relationship with the user (701). The determining of the interest object may be achieved based on the user's input or information acquired through a smart electronic device controlled by the user, but is not limited thereto. Examples of a method of determining an interest object have been described in detail with reference to FIGS. 3 and 4.

Subsequently, a subjective relationship between the determined interest object and the user is identified (702). In this case, the subjective relationship with respect to the user is identified as the determined interest object is recognized from an image acquired using a smart electronic device controlled by the user. Alternatively, the subjective relationship with respect to the user may be identified using subjective relationship information in an interest object list. However, the identifying of the interest object is not limited thereto. The subjective relationship is a unique relationship between a user and a corresponding interest object. An example of a method of identifying a subjective relationship has been described in detail with reference to FIG. 1.

Thereafter, additional information representing a current relationship state between the interest object and the user is generated (703). In this case, the additional information may be generated using the identified subjective relationship. Alternatively, the additional information may be generated using subjective interaction information that expresses an interaction previously occurring between each interest object registered in the interest object list and the user. Alternatively, the additional information may be generated using subjective interaction information with respect to each interest object and objective object information about each interest object. Examples of a method of generating additional information has been described in detail with reference to FIGS. 6 and 7.

Thereafter, the generated additional information is provided to the user (704). The user using the augmented reality providing apparatus may allow the additional information to be displayed together with the interest object, or allow only the additional information to be displayed. However, the providing of the additional information is not limited thereto. For example, the generated additional information may be selected based on a predetermined priority. The priority may be set by the user in advance or determined in the order of a most recent time. The providing of the additional information is not limited thereto, however. An example of a method of providing additional information has been described in detail with reference to FIG. 1.

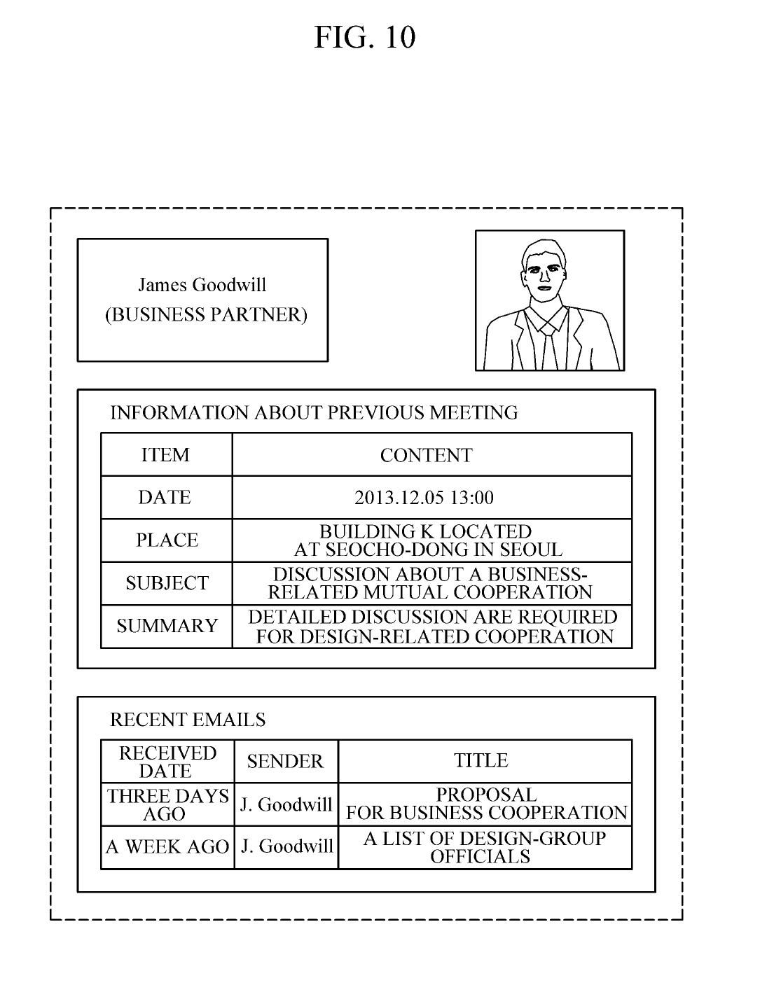

FIGS. 10 to 13 illustrate examples of a relationship-based personalized augmented reality provided to a user.

FIG. 10 illustrates an example of a relationship-based personalized augmented reality provided when an interest object is ‘James Goodwill’. For example, a user meets ‘James Goodwill’, who is a business partner with the user, at 1 pm, Dec. 5, 2013 in the building K located in Seocho-dong, Seoul, to discuss a business-related mutual cooperation. The user registers ‘James Goodwill’ as an interest object having a business partner relationship, and stores subjective relationship information, subjective interaction information, and objective object information about ‘James Goodwill’ in an interest object list. Thereafter, when the user again meets ‘James Goodwill’ and determines ‘James Goodwill’ as an interest object using a relationship-based personalized augmented reality providing apparatus, the subjective relationship information ‘a business partner’ and the subjective interaction information ‘information about a previous meeting and recent emails’ are provided as additional information by the relationship-based personalized augmented reality providing apparatus. In addition, detailed information ‘date, place, subject, and summary’ may be provided as the additional information ‘information about a previous meeting’ with respect to ‘James Goodwill’ by the relationship-based personalized augmented reality providing apparatus, and detailed information ‘a received date, a sender, and a title’ may be provided as the additional information ‘information about recent emails’ by the relationship-based personalized augmented reality providing apparatus. In addition, using the subjective interaction information ‘information about a previous meeting and recent emails’ associated between the interest object ‘James Goodwill’ and the user and using the objective object information ‘contact information and email address of James Goodwill’ about ‘James Goodwill’, additional information ‘sending James Goodwill an email regarding the previous meeting’ is generated as a recommended interaction to be provided to the user by the relationship-based personalized augmented reality providing apparatus.

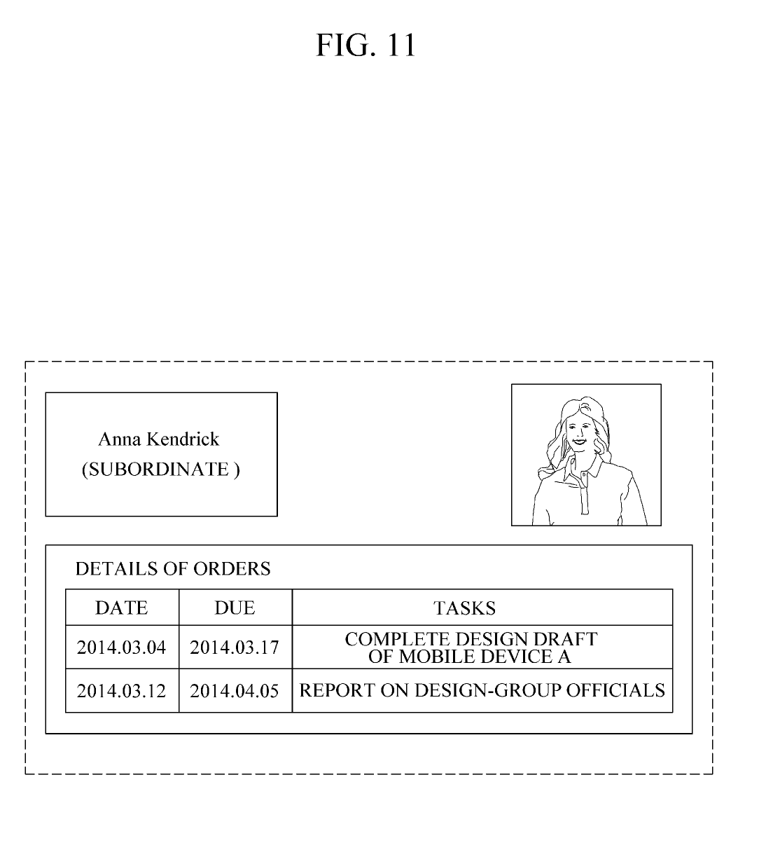

FIG. 11 illustrates an example of a relationship-based personalized augmented reality provided when an interest object is ‘Anna Kendrick’. For example, a user registers ‘Anna Kendrick’ as an interest object, and stores subjective relationship information ‘a subordinate’, and subjective interaction information ‘details of orders’. Thereafter, when the user meets ‘Anna Kendrick’ and determines ‘Anna Kendrick’ as an interest object using a relationship-based personalized augmented reality providing apparatus, the subjective relationship information with respect to the user ‘a subordinate’ and the subjective interaction information with respect to the user ‘details of orders’ are provided as additional information by the relationship-based personalized augmented reality providing apparatus. In addition, detailed information ‘order dates, due dates, and task details’ may be provided as the additional information ‘details of orders’ with respect to ‘Anna Kendrick’ by the relationship-based personalized augmented reality providing apparatus. In addition, using the subjective interaction information ‘details of orders’ associated between the interest object ‘Anna Kendrick’ and the user, and using the objective object information ‘contact information and email address of Anna Kendrick’ about Anna Kendrick, additional information ‘querying Anna Kendrick whether a design draft of a mobile device A is completed’ is generated as a recommended interaction to be provided to the user by the relationship-based personalized augmented reality providing apparatus.

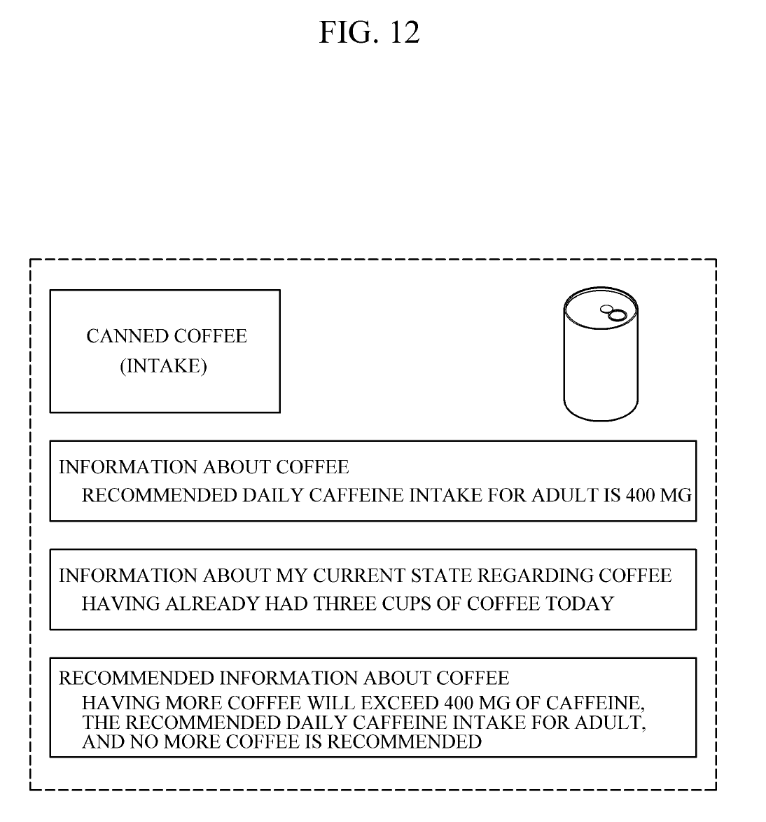

FIG. 12 illustrates an example of a relationship-based personalized augmented reality provided when an interest object is ‘canned coffee’. For example, a user registers ‘canned coffee’ as an interest object and stores subjective relationship information ‘a relationship regarding intake’, and subjective interaction information ‘having already had three cups of canned coffee today’. Thereafter, when the user determines ‘canned coffee’ as an interest object, the subjective relationship information ‘a relationship regarding intake’ associated between the user and ‘canned coffee’, the subjective interaction information with respect to the user ‘having already had three cups of canned coffee today’, and objective object information about canned coffee ‘a recommended daily caffeine intake for adult is 400 mg’ are provided as additional information by the relationship-based personalized augmented reality providing apparatus.

In addition, by using the subjective interaction information ‘having already had three cups of canned coffee today’ associated between ‘canned coffee’ and the user and using the objective object information ‘a recommended daily caffeine intake for adult is 400 mg’, additional information ‘having more coffee will exceed 400 mg of caffeine, the recommended daily caffeine intake for adult, and no more coffee is recommended’ is generated as a recommended interaction to be provided to the user by the relationship-based personalized augmented reality providing apparatus.

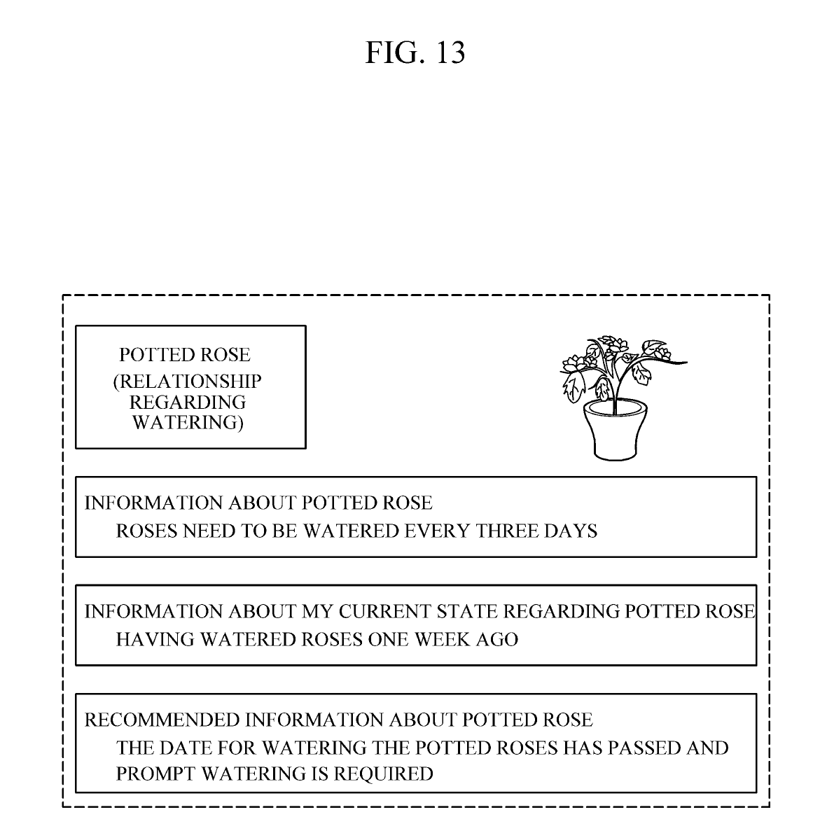

FIG. 13 illustrates an example of a relationship-based personalized augmented reality provided when an interest object is ‘a potted rose’. For example, a user registers ‘a potted rose’ as an interest object and stores subjective relationship information ‘a relationship regarding watering’, and subjective interaction information ‘having watered roses one week ago’. Thereafter, when the user determines ‘a potted rose’ as an interest object, the subjective relationship information ‘a relationship regarding watering’ associated between ‘a potted rose’ and the user, the subjective interaction information ‘having watered roses one week ago’, and objective object information about a potted rose ‘roses need to be watered every three days’ are provided as additional information by the relationship-based personalized augmented reality providing apparatus.

In addition, by using the subjective interaction information ‘having watered roses one week ago’ associated between the potted rose and the user, and using the objective object information about the potted rose ‘roses need to be watered every three days’, additional information ‘the date for watering the potted roses has passed and prompt watering is required’ is generated as a recommended interaction to be provided to the user by the relationship-based personalized augmented reality providing apparatus.

The technologies disclosed in this disclosure may be used in smart glasses-oriented augmented reality applications and mobile device-oriented augmented reality applications, such as smartphones and tablet PCs, but the application of the technologies disclosed in this disclosure is not limited thereto.

As is apparent from the above description, additional information is generated based on subjective information associated between a user and a user's interest object (a human or object), objective object information about the user's interest object (a human or object), or additional information generated based on the objective object information and subjective information as augmented reality information to conform to a current situation in consideration of a relationship between the user and the user's interest object (a human or object), thereby providing enhanced suitability and usability of user-based personalized information.

The interest object determiner 100, the relationship identifier 200, the additional information generator 300, the additional information provider 400, and the storage 500 in FIGS. 1 and 2 that perform the various operations described with respect to FIGS. 1-13 may be implemented using one or more hardware components, one or more software components, or a combination of one or more hardware components and one or more software components.

A hardware component may be, for example, a physical device that physically performs one or more operations, but is not limited thereto. Examples of hardware components include resistors, capacitors, inductors, power supplies, frequency generators, operational amplifiers, power amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A personalized augmented reality providing apparatus comprising:
an interest object determiner configured to determine an interest object among external objects each having a predetermined relationship with a user;
a relationship identifier configured to identify a subjective relationship between the interest object determined by the interest object determiner and the user;
an additional information generator configured to generate additional information representing a current relationship state between the interest object and the user based on the subjective relationship identified by the relationship identifier; and
an additional information provider configured to provide the user with the additional information generated by the additional information generator.

2. The personalized augmented reality providing apparatus of claim 1, wherein the interest object determiner is further configured to determine the interest object based on an input of the user or information acquired through a smart electronic device controlled by the user.

3. The personalized augmented reality providing apparatus of claim 1, wherein the relationship identifier is further configured to identify the subjective relationship with respect to the user by recognizing the interest object determined by the interest object determiner from an image acquired by a smart electronic device controlled by the user.

4. The personalized augmented reality providing apparatus of claim 1, further comprising a storage configured to store an interest object list in which interest objects for which the additional information is to be provided to the user are registered;
wherein the interest object determiner is further configured to determine, as the interest object, an external object included in the interest object list among the external objects.

5. The personalized augmented reality providing apparatus of claim 4, wherein the interest object list comprises subjective relationship information indicating the subjective relationship for each of the interest objects registered in the interest object list; and
the relationship identifier is further configured to identify the subjective relationship with respect to the user using the subjective relationship information in the interest object list.

6. The personalized augmented reality providing apparatus of claim 4, wherein the storage is further configured to store subjective interaction information expressing an interaction previously occurring between the user and each of the interest objects registered in the interest object list; and
the additional information generator is further configured to generate the additional information using the subjective interaction information.

7. The personalized augmented reality providing apparatus of claim 6, wherein the additional information generator is further configured to generate the additional information using objective object information about each of the interest objects.

8. The personalized augmented reality providing apparatus of claim 7, wherein the objective object information is stored in the storage or acquired by the additional information generator through communication with an external database.

9. The personalized augmented reality providing apparatus of claim 7, wherein the current relationship state indicates an interaction expressed by the subjective interaction information or indicates a recommended interaction determined using an interaction expressed by the subjective interaction information and the objective object information.

10. The personalized augmented reality providing apparatus of claim 1, wherein the additional information provider is further configured to select the additional information generated by the additional information generator according to a predetermined priority, and provide the selected additional information to the user.

11. The personalized augmented reality providing apparatus of claim 10, wherein the priority is set by the user in advance, or determined in order of a most recent time.

12. A personalized augmented reality providing method comprising:
determining an interest object among external objects each forming a predetermined relationship with a user;
identifying a subjective relationship between the determined interest object and the user;
generating additional information representing a current relationship state between the interest object and the user based on the identified subjective relationship; and
providing the user with the generated additional information.

13. The personalized augmented reality providing method of claim 12, wherein the determining of the interest comprises determining the interest object based on an input of the user or information acquired through a smart electronic device controlled by the user.

14. The personalized augmented reality providing method of claim 12, wherein the determining of the interest object comprises determining an external object included in an interest object list in which interest objects are registered to be the interest object among the external objects.

15. The personalized augmented reality providing method of claim 14, wherein the interest object list comprises subjective relationship information indicating the subjective relationship for each of the interest objects registered in the interest object list; and
the identifying of the subjective relationship comprises identifying the subjective relationship with respect to the user using the subjective relationship information in the interest object list.

16. The personalized augmented reality providing method of claim 14, wherein the interest object list comprises subjective interaction information expressing an interaction previously occurring between the user and each of the interest objects registered in the interest object list; and
the generating of the additional information comprises generating the additional information using the subjective interaction information.

17. The personalized augmented reality providing method of claim 16, wherein the generating of the additional information comprises generating the additional information using objective object information about each of the interest objects.

18. The personalized augmented reality providing method of claim 17, wherein the objective object information is stored in the interest object list or acquired through communication with an external database.

19. The personalized augmented reality providing method of claim 17, wherein the current relationship state indicates an interaction expressed by the subjective interaction information, or indicates a recommended interaction determined using an interaction expressed by the subjective interaction information and the objective object information.

20. The personalized augmented reality providing method of claim 12, wherein the providing of the user with the generated additional information comprises selecting the generated additional information according to a predetermined priority, and providing the selected additional information to the user.

21. A personalized augmented reality providing apparatus comprising:
an additional information generator configured to generate additional information about a relationship state between an external object and a user based on a relationship between the external object and the user; and
an additional information provider configured to provide the user with the additional information.

22. The personalized augmented reality providing apparatus of claim 21, further comprising an object determiner configured to identify the external object from a plurality of external objects each having a predetermined relationship with the user.

23. The personalized augmented reality providing apparatus of claim 21, further comprising a relationship identifier configured to identify the relationship between the external object and the user.

24. The personalized augmented reality providing apparatus of claim 21, wherein the additional information generator is further configured to generate the additional information based on any one or any combination of:
relationship information indicating the relationship between the external object and the user;
interaction information expressing a previous interaction between the external object and the user; and
object information about the external object.

25. The personalized augmented reality providing apparatus of claim 24, wherein the relationship state indicates an interaction expressed by the interaction information or a recommended interaction determined based on the previous interaction expressed by the interaction information and the object information.
